(19) United States
(12) Patent Application Publication
(10) Pub. No.: US 2005/0116577 A1
(43) Pub. Date: Jun. 2, 2005

(54) Holder for a carbon brush

(76) Inventors: Holger Busse, Duderstadt (DE); Wolfgang Kasdorf, Aabergen (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/504,155

(22) PCT Filed: Feb. 21, 2003
(86) PCT No.: PCT/EP03/01792

(30) Foreign Application Priority Data
Feb. 21, 2002 (DE) 10207406.2

(51) Int. Cl. H02K 13/00

(52) U.S. Cl. 310/239

(57) ABSTRACT

A holder for a carbon brush, particularly one which may be applied to a commutator, includes a spring element with a fixing section and a support section for housing the carbon brush. According to the invention, a secure fixing of the carbon brush may be achieved in which the carbon brush has a material connection to the support section.

The invention relates to a holder for a carbon brush, particularly one which may be applied to a commutator or a collector ring with a front area, comprising a spring element with a possibly U- or L-shaped fixing section and a support section for housing the carbon brush.

A corresponding holder is disclosed e.g. in DE 199 62 705 A1. In order to fix the carbon brush, the support section comprises an opening, through which the carbon brush extends for fastening it through insulation displacement contact. Since the carbon brush extends in sections on the back along the support section, a minimum installation depth is required, which can lead to significant problems especially with small-power motors. This insulation displacement contact results additionally in a notch effect, which can lead to problems during vibrations. Since the rear area of the carbon brushes extending through the support section frequently has a smaller cross-section than the section facing a commutator, on which the carbon brush rests for current transfer purposes, it is necessary from a manufacturing aspect to press the carbon brush material in the longitudinal direction of the carbon brush to be produced.

From U.S. Pat. No. 4,638,201 we know of a holder for a carbon brush. The holder consists of an L-shaped spring element, the one leg of which comprises a U-shaped dent, in which a carbon brush can be fixed.

In a holder pursuant to DE 199 62 705 A1, the support section comprises an opening through which a carbon brush extends for fastening it through insulation displacement contact. Since the carbon brush extends in sections on the back along the support section, a minimum installation depth is required, which can lead to significant problems especially with small-power motors. This insulation displacement contact results additionally in a notch effect, which can lead to problems during vibrations. Since the rear area of the carbon brushes extending through the support section frequently has a smaller cross-section than the section facing a commutator on which the carbon brush rests for current transfer purposes, it is necessary from a manufacturing aspect to press the carbon brush material in the longitudinal direction of the carbon brush to be produced.

An electric motor for small units pursuant to DE 24 13 578 A1 comprises holders for carbon brushes designed as leaf springs, which each comprise a prismatic extension that can be fixed in a cut-out section of the leaf spring through a notch effect.

From DE 23 30 689 A1 we know of a carbon brush holder for small electric machines. Here a carbon brush comprises a projection with a small cross-section that has a single-piece design with the carbon brush, extends through an opening of a spring element, and is fixed by means of resilient flaps.

The present invention is based on the object of further developing a holder of the afore-mentioned kind, especially one intended for small carbon brushes for motor vehicle manufacture, in such a way that secure fixing of the carbon brush while avoiding a notch effect is possible, wherein the installation space shall be minimized. Moreover it shall be ensured that the contact resistance between the carbon brush and its holder is as low as possible.

Pursuant to the invention this object is achieved essentially in that the carbon brush is intimately connected with the support section and/or is connected thereto with a material connection, wherein in particular a connection by means of gluing with a conductive adhesive or welding or in particular soldering occurs. Hereby the carbon brush is especially metal-coated on the support side, such as nickel-, tin- and/or copper-plated.

In a further development it is provided that the support section of the holder comprises a support surface that supports the carbon brush on the back, as well as retention or guide sections protruding from the support section and extending along at least two opposing lateral surfaces of the carbon brush. In particular it is provided that the carbon brush is connected along its back to the support surface in a non-positive manner.

Pursuant to the invention the carbon brush is supported over a large area on the support section itself so that the carbon brush does not extend beyond the back of the support section. Consequently the installation depth is solely dependent upon the effective length of the carbon brush interacting with a commutator or collector ring. Moreover the carbon brush can be fixed without insulation displacement contact so that in particular in the case of vibrations disadvantageous notch effects are eliminated.

Apart from the intimate connection, additional fixation and hence securing of the carbon brush is achieved especially through the retention or guide sections having a clamping effect on at least two lateral surfaces of the carbon brush.

In a further development of the invention it is provided that a retention or guide section protruding from the support section of the spring element extends in particular along each lateral surface, wherein the retention or guide section is a freely cut section that is bent out from the plane formed by the support section.

Preferably two retention or guide sections, such as lugs, extend along each lateral surface of the carbon brush. Hereby the carbon brush can be fixed in a clamping manner by means of the retention or guide sections.

The carbon brush as such can be a block carbon brush or a hammer carbon brush.

Since due to the holder designed pursuant to the invention and the associated fixation of the carbon brush in the back area the cross-section of the carbon brush remains constant, it offers the benefit that a preferred direction must not be adhered to for pressing the carbon brush material. Hence it is feasible without difficulty to use carbon brushes that are pressed perpendicular or parallel to the longitudinal axis of the finished carbon brush.

Further details, advantages and features of the invention result not only from the claims, the features disclosed therein—alone and/or in combination, but also from the following description of preferred exemplary embodiments disclosed in the drawings.

They show:

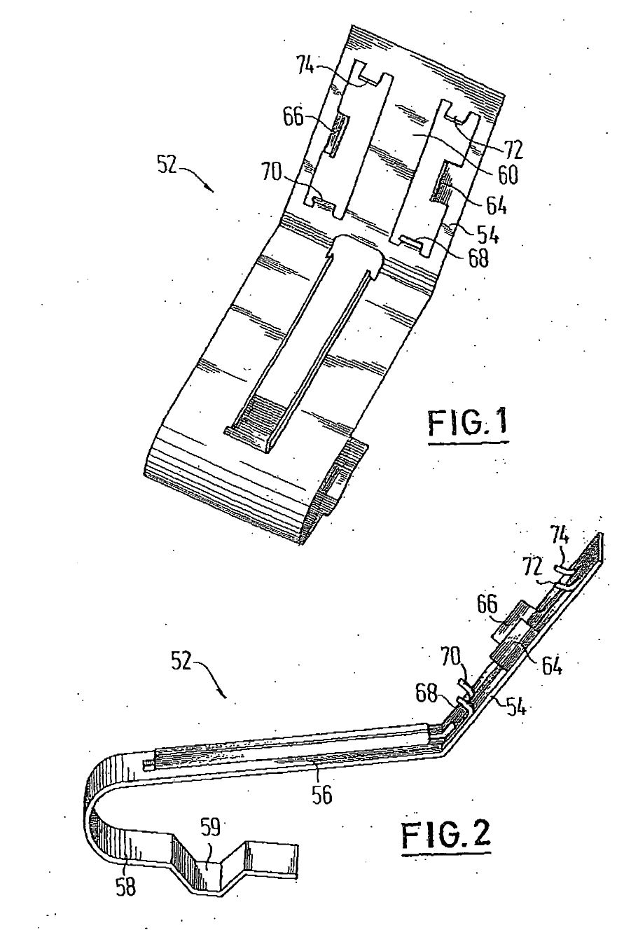

FIG. 1 in diagrammatic view a top view onto the carbon brush holder,

FIG. 2 in diagrammatic view a side view of the carbon brush holder from FIG. 1,

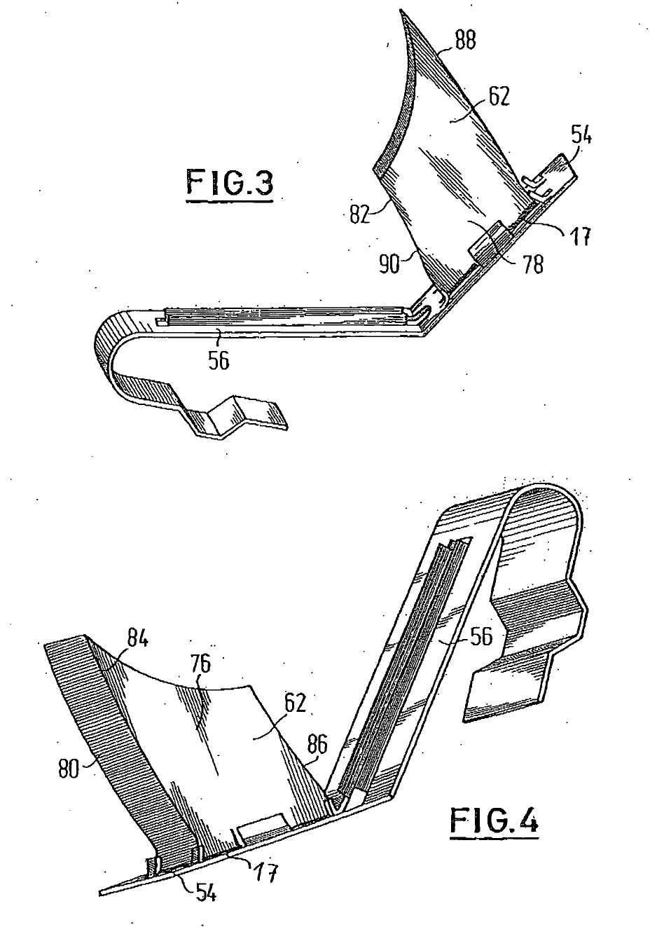

FIG. 3 the carbon brush holder from FIGS. 1 and 2 with a carbon brush extending therefrom,

FIG. 4 the holder with carbon brush revealed in FIG. 3 in a deviating diagrammatic illustration, and

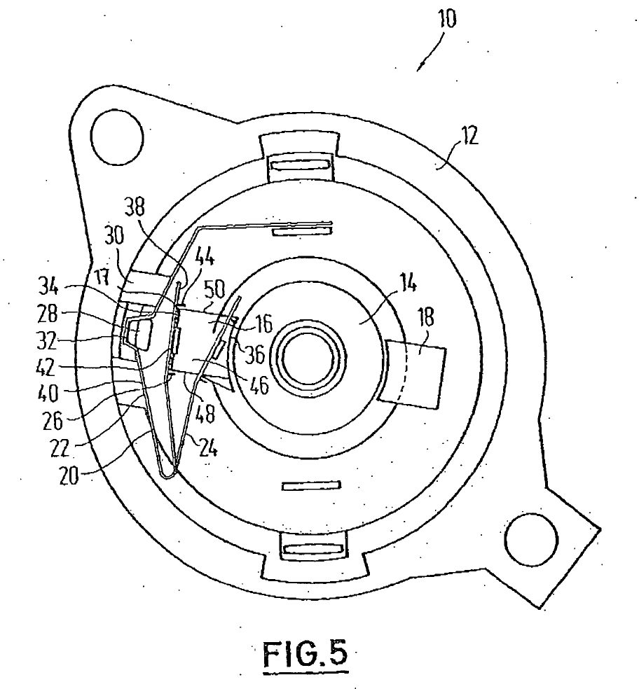

FIG. 5 a representative illustration of a carbon brush arranged in a small-power motor.

FIG. 5 shows a mere principle of a small-power motor 10 with a motor housing 12 and an electric motor with commutator 14 arranged thereon, to which carbon brushes 16, 18 are applied for current transfer purposes. The carbon brushes 16 and 18 each extend from a holder 20, which is only representatively illustrated with the carbon brush 16, in the form of a leaf spring, the function of which is known and which comprises a fixing leg or fixing section 22 and a support section 24 housing the carbon brush 16. The fixing section 22 is fixed between the bearings and abutments 26, 28 and 30 in the familiar fashion. For this purpose the fixing section 22 comprises a section 32 that is arched U-shaped in its profile, which surrounds the bearing 28, while the adjoining sections rest against the abutments 26 and 30 across a surface. This creates a clear fixation of the holder 20, wherein due to the prestress of the support section 24 in relation to the fixing section 22 the carbon brush 16 extending from the support section 24 is subjected to the necessary force in the direction of the commutator 14.

The carbon brush 16 pursuant to the invention is intimately connected to the support section 24, such as welded or in particular soldered thereto. To this end, the area of the carbon brush 16 that is intimately connected to the support section 24 can be tin-, nickel-, or copper-plated or can be metal-coated in another suitable fashion.

The carbon brush 16 rests with its rear surface 34, which extends opposite the front area 36 that is applied to the commutator 14, on the side 38 of the support section 24 that faces the commutator, and is intimately connected thereto. The corresponding metal-coated area of the carbon brush 16 is marked with the reference number 17. Moreover fixation occurs by means of outwardly bent flaps or lugs 42, 44 that are freely cut from the support section 24 and/or its surface 38 forming a plane, wherein at least one flap or one lug 40, 42, 44 extends along a lateral surface 46, 48, 50 of the carbon brush 16. This way the carbon brush 16 is held in a guided fashion to the required extent and if necessary it is fixed by clamping without the presence of insulation displacement contact that would lead to a notch effect, as is the case in the prior art.

The flaps or lugs 40, 42, 44 can also alone have the function of a guide to the carbon brush 16 so as to position it clearly in relation to the support section 24 and then connect it to the support section 24 e.g. through soldering or welding.

FIGS. 1 through 4 reveal another preferred embodiment of a holder 52, the basic design of which however corresponds to the holder 20, with said holder consisting of a support section 54 and a U-shaped bent fixing section 56, wherein its free end leg 58 comprises a U-shaped bent section 59, which for the purpose of fixing the carbon brush holder 52 encloses a bearing corresponding to the bearing 28 pursuant to FIG. 5. The U-shaped section 59 comprises legs diverging from each other starting from the traverse or base leg, as illustrated in FIG. 2.

The support section 54 comprises a freely cut surface 60, on which a carbon brush like the carbon brush 62 illustrated in FIGS. 3 and 4 rests with its rear surface and is intimately connected thereto, such as soldered (area 17). To guide and s if necessary further fix the carbon brush 62, retention or guide sections 64, 66, 68, 70, 72, 74 can be freely cut and be bent out from the plane formed by the surface 60, said sections extending along the lateral outer surfaces 76, 78, 80, 82 when the carbon brush 62 is positioned and possibly holding the carbon brush 62 in a clamping fashion. The clamping fixation however is not an absolutely required feature since the flat retention sections or lugs 64, 66, 68, 70, 72, 74 in the actual sense must provide axial guidance on their own to the carbon brush 62, which due to the spring effect of the support section 54 applies the carbon brush 62 to a commutator.

As can be seen in particular in FIGS. 3 and 4, two retention or guide sections or lugs 68, 70 or 72, 74 extend along the narrow sides 80, 62 [sic] of the carbon brush 62, and one retention or guide section or holder section 64, 66 extends along the wide sides 76, 78, which are wider than those running on the narrow sides 80, 62 [sic]. From each longitudinal edge 84, 86, 88, 90 of the carbon brush 62 a holder lug 68, 70, 72, 74 extends, wherein together with the lugs 64, 66 extending along the remaining longitudinal lateral surfaces 76, 78 of the carbon brush 62 the carbon brush 62 is axially guided such that its rotation is out of the question. Hence additional securing is provided should the intimate connection between the carbon brush 62 or its metal-coated area 17 and the support section 54 be destroyed.

The wide sides 76, 78 of the carbon brush 62 extend in the exemplary embodiment along the longitudinal axis of the support section 54.

Since the carbon brush 62 rests over a large area on the plane formed by the support section 54, namely the support surface 60, flawless application of the carbon brush 62 to a commutator is ensured even when vibrations occur. Since additionally the carbon brush 62 does not extend through the support section 54, a lesser installation depth is required.

In particular when using block carbon brushes it is beneficial that the pressing-ready mixture that is required for the manufacture of the carbon brush can be pressed in the desired direction in relation to the longitudinal axis of the carbon brush, i.e. for example parallel to the longitudinal direction of the finished carbon brush or perpendicular to it.

The intimate connection by soldering can be implemented in that the carbon brush is guided with its back through a tin bath in order to then be connected with the holder.

It is also possible to establish an intimate or non-positive connection by using an electrically conductive adhesive between the carbon brush and holder.

1. Holder (20, 52) with a carbon brush (16, 18, 62), particularly one which may be applied to a commutator (14) or a collector ring with a front area (36), comprising a bent spring element with a possibly U- or L-shaped fixing section (22, 56) and a support section (24, 54) for housing the carbon brush, wherein the carbon brush has a material connection with the support section, characterized in that the support section (24, 54) of the holder (20, 52) comprises a freely cut support surface (60) supporting the rear surface of the carbon brush (16, 62) as well as guide sections (40, 42, 44, 64, 66, 68, 70, 72, 74) protruding from the support section and extending along at least two opposing lateral surfaces (46, 48, 50) of the carbon brush, that the guide sections (40, 42, 44, 64, 66, 68, 70, 72, 74) are cut freely out of the support section (24, 54) of the holder (20, 52) and bent out from the plane formed by the support section (24, 54), and that the carbon brush (16, 52) has a material connection to the support surface by means of soldering or welding or by means of an electrically conductive adhesive.

2. Holder pursuant to claim 1, characterized in that the carbon brush (16, 62) is metal-coated such as tin-, nickel, or copper-plated on the support section side.

3. Holder pursuant to claim 1, characterized in that at least one retention or guide section (40, 42, 44, 64, 66, 68, 70, 72, 74) protruding from the support section (24, 54) of the holder (20, 52) extends along each lateral surface (46, 48, 50, 76, 78, 80, 82) of the carbon brush (16, 62).

4. Holder pursuant to claim 1, characterized in that two retention or guide sections (68, 70; 72, 74) extend along the narrow sides (80, 82) of the carbon brush (62), and one retention or guide section (64, 66) extends along the wide sides (76, 78) of the carbon brush.

5. Holder pursuant to claim 1, characterized in that at least one retention or guide section (68, 70, 72, 74) extends from each edge (86, 88, 90) of the carbon brush (62).

6. Holder pursuant to claim 1, characterized in that the retention or guide sections (64, 66, 68, 70, 72, 74) fix the carbon brush (62) in a clamping fashion.

7. Holder pursuant to claim 1, characterized in that the carbon brush is a block carbon brush or a hammer carbon brush.

8. Holder pursuant to claim 1, characterized in that the carbon brush is pressed perpendicular to its longitudinal axis.

9. Holder pursuant to claim 1, characterized in that the carbon brush is pressed parallel to its longitudinal axis.
